(19) United States
(12) Patent Application Publication
(10) Pub. No.: US 2012/0183292 A1
(43) Pub. Date: Jul. 19, 2012

(54) METHOD AND APPARATUS FOR TRAFFICKING WAVELENGTHS OF DIFFERENT SPACINGS WITHIN AN OPTICAL NODE

(75) Inventor: Mark E. Boduch, Geneva, IL (US)

(73) Assignee: Tellabs Operations, Inc., Naperville, IL (US)

(21) Appl. No.: 13/177,089

(22) Filed: Jul. 6, 2011

Related U.S. Application Data
(60) Provisional application No. 61/450,444, filed on Mar. 8, 2011.
(60) Provisional application No. 61/433,155, filed on Jan. 14, 2011.

(51) Int. Cl. H04J 14/02

(52) U.S. Cl. 398/48; 398/79

(57) ABSTRACT

Fiber optic links can be used to support optical communications using wavelength division multiplexing (WDM) with different legacy, current, and future (non-legacy) WDM systems being characterized by channel spacing. An example of a legacy system can include WDM that employs a large number of channels and uses relatively narrow spacing between the channels, having a channel spacing of 100 GHz whereas today's current WDM systems have a narrower channel spacing of 50 GHz. Current systems and standards cannot support multiplexing of signals from different legacy and non-legacy WDM systems within the same network element without causing signal interference. Example embodiments of the present invention overcome the current problems by allowing for the handling and interconnection of differently spaced wavelengths within the same network element by employing hybrid components. As a result, networks employing embodiments of the present invention have reconfigurable, scalable, low cost interoperability of legacy and non-legacy WDM systems.

### RELATED APPLICATIONS

This application claims the benefit of U.S. Provisional Application No. 61/450,444, filed on Mar. 8, 2011, which is related to U.S. Provisional Application No. 61/433,155, filed on Jan. 14, 2011, entitled, “A Method and Apparatus for Mixing Wavelengths of Different Spacings within an Optical Node,” the entire teachings of both being incorporated herein by reference.

### BACKGROUND OF THE INVENTION

In existing Reconfigurable Optical Add/Drop Multiplexer (ROADM) based optical nodes, a set of add ports and a set of drop ports are dedicated to a given output network node interface. Attached to a given add/drop port is an optical transponder. The optical transponder provides the ability to convert a “white light” non-colored optical signal to a colored optical signal (and vice versa). The ROADM then provides the ability to multiplex multiple optical signals into a single multi-wavelength wavelength division multiplexed optical signal.

Wavelength Division Multiplexing (WDM) is a method by which single-mode optical fibers are used to carry multiple light waves of different frequencies. In a WDM network, many wavelengths are combined in a single fiber, thus increasing the carrying capacity of the fiber. Signals are assigned to specific frequencies of light (wavelengths) within a frequency band. This multiplexing of optical wavelengths is analogous to the way radio stations broadcast on different wavelengths as to not interfere with each other. Because each channel is transmitted on a different wavelength, a desired channel may be selected using a tuner. WDM channels (wavelengths) are selected in a similar manner. In a WDM network, all wavelengths are transmitted through a fiber, and de-multiplexed at a receiving end. The fiber's capacity is an aggregate of the transmitted wavelengths, each wavelength having its own dedicated bandwidth.

Dense Wavelength Division Multiplexing (DWDM) is a WDM network in which wavelengths are spaced more closely than in a coarse WDM network. This provides for a greater overall capacity of the fiber.

### SUMMARY OF THE INVENTION

An example embodiment of the present invention includes methods, apparatuses, and network elements for combining wavelengths of different spacings within an optical node. Such an example embodiment includes a Reconfigurable Optical Add Drop Multiplexer (ROADM) with a first express path configured or operable to be configured to pass wavelengths from an ingress side of the ROADM to an egress side of the ROADM, and further includes a second express path that restricts, or is operable to restrict, a first subset of the wavelengths and only passes the wavelengths of the remaining subset (e.g., a second subset) from the ingress side to the egress side of the ROADM.

Alternative example embodiments of the present invention include a method for trafficking an optical signal in a ROADM by passing wavelengths on a first express path from an ingress side of the ROADM to an egress side the ROADM. The method further includes restricting a first subset of the wavelengths from being trafficked on a second express path, but passing a second subset of the wavelengths on the second express path from the ingress side of the ROADM to the egress side of the ROADM.

Further alternative example embodiments of the present invention can include a multi-degree optical node, where the optical node can include or be operably interconnected to at least two ROADMs. A first ROADM can be selectably configured or is operable to be configured (or programmed) to traffic wavelengths via a first express path in the ROADM or the first ROADM can be selectably configured, or is operable to be configured (or programmed), to traffic only a subset of the wavelengths via a second path, the first ROADM being optically coupled to a second ROADM, where the second ROADM can be configured or is operable to be configured to receive the wavelengths or the subset of the wavelengths and to traffic wavelengths received via an express path.

Further example embodiments of the present invention include an optical network including at least two optical nodes being operably interconnected to each other via at least one inter-network node path. The first optical node can be selectably configured to traffic first wavelengths or a subset of the first wavelengths, and the second optical node can be configured to traffic second wavelengths. In such an example embodiment, the first optical node can be configured to traffic the first wavelengths to the second optical node if the first wavelengths correspond to the second wavelengths, and the first optical node can further be configured to traffic the subset of the first wavelengths if the subset of the wavelengths corresponds to the second wavelengths.

Further example embodiments can include a method for trafficking an optical signal in an optical network by allowing a subset of wavelengths to pass through a given hybrid ROADM toward a non-hybrid ROADM capable of handling only the subset of the wavelengths. The method may further include allowing off-grid and on-grid wavelengths to pass through the given hybrid ROADM toward another hybrid ROADM or a non-hybrid ROADM capable of handling all of the wavelengths.

### BRIEF DESCRIPTION OF THE DRAWINGS

The foregoing will be apparent from the following more particular description of example embodiments of the invention and as illustrated in the accompanying figures. The drawings are not necessarily to scale, emphasis instead being placed upon illustrating example embodiments of the present invention.

FIG. 1 is a network diagram of an example embodiment of the invention that illustrates an optical network.

FIG. 2 is a block diagram of an embodiment of the present invention that illustrates a hybrid reconfigurable optical add/drop multiplexer.

FIG. 3 is a block diagram of an embodiment of the present invention that illustrates a hybrid reconfigurable optical add/drop multiplexer.

FIG. 4 is a block diagram of an embodiment of the present invention that illustrates interconnected hybrid reconfigurable optical add/drop multiplexers.

FIG. 5 illustrates a block diagram of an example embodiment of an optical node according to example embodiments of the present invention.

FIG. 6 is an optical network diagram of an embodiment of the present invention illustrates at least two optical nodes.

FIG. 7A is a block diagram of an example embodiment of the present invention that illustrates the interference or overlap associated with 100 GHz channels and 50 GHz channels.

FIG. 7B is a block diagram that illustrates an optical interleaver and de-interleaver of an example embodiment of the present invention.

FIG. 7C is a spectral diagram that illustrates the spectrums of three consecutive 10 Gbps wavelengths spaced apart by 50 GHz.

FIG. 8A is a flow diagram of an embodiment of the present invention that illustrates a method of trafficking optical signals.

FIG. 8B is a flow chart of an embodiment of the present invention that illustrates a method of trafficking optical signals.

FIG. 9A is a flow diagram of an embodiment of the present invention that illustrates a method of trafficking an optical signal.

FIG. 9B is a flow chart 900b of an embodiment of the present invention that illustrates a method of trafficking an optical signal.

FIG. 10 is a block diagram of a network such as the optical node according to an example embodiment of the present invention.

### DETAILED DESCRIPTION OF THE INVENTION

A description of example embodiments of the invention follows.

Before describing embodiments of the present invention, a brief description of history and current developments of the art is presented.

Fiber optic links, or fibers, can be used for optical fiber communication using different techniques, such as wavelength division multiplexing (WDM). Although the entire data transmission bandwidth (capacity) of a fiber can be used as a single logical or physical channel through the fiber with a very large bandwidth and data rate, such use of the fiber is not favorable for many reasons commonly known in the art. However, WDM can be employed to maintain a high combined data rate by aggregating many channels, where each channel “exists” on a different wavelength and the transmission rates of each channel are maintained at relatively low levels (e.g., 10 gigabytes/per second (Gbps)).

Currently, there exist different forms of WDM, such as coarse WDM (CWDM), which employs only a small number channels (e.g., 4-10 channels), and each channel has relatively wide spacing (e.g., 20 nm). Another example of WDM is dense WDM (DWDM), which employs a larger number of channels (e.g., 44, 88, etc.), and each channel has relatively narrow wavelength spacing (e.g., 100 GHz, 50 GHz, 25 GHz, etc.). As technology is furthered, narrower wavelength spacings, higher data transmission rates, and additional aspects and components of WDM and optical transmission will continue to change.

Current systems for optical transmission can include many components (e.g., optical amplifiers, interleavers and de-interleavers, filters, optical switches, and reconfigurable optical add/drop multiplexers). One such component, namely the reconfigurable add/drop multiplexer (ROADM), can be employed in optical systems, such as a WDM network, in order to provide for flexible management of data connections, and can be used to add and drop wavelengths from respective DWDM signals at the requested or determined port, destination, network, or network component. See, e.g., International Telecommunications Union (ITU) Standard G. 694.1 (June 2002) or ITU Standard G.694.2 (December 2003).

Current standards support 44-channel ROADMs (i.e., having 44 wavelengths spaced apart by 100 GHz) and 88-channel ROADMs (i.e., having 88 wavelengths spaced apart by 50 GHz). Currently, an 88-channel ROADM cannot be optically interconnected to a 44-channel ROADM within the same system. This is because, from the incoming direction (e.g., from a line-in or line interface), the optical signal containing all wavelengths (i.e., all wavelengths on channels 1-88) is broadcast to all Wavelength Selective Switches (WSSs) on all ROADMs. In other words, if a line interface receives a signal containing 88 wavelengths, the express input on an 88-channel WSS (i.e., 100 GHz WSS) receives all 88 wavelengths. There is no mechanism to block the off-grid 44 wavelengths (i.e., wavelengths on channels 45-88) to the 100 GHz WSS other than by not connecting the express fiber containing the 88 channels to the 100 GHz based ROADM. If a 100 GHz WSS receives 50 GHz spaced wavelengths, then, because of the wide 100 GHz filters in the WSS, signal power within the two off-grid (50 GHz) wavelengths (on either side of an on-grid (100 GHz) wavelength) leaks into the on-grid channel. Such spill-over interferes with the signal within the on-grid channel, which results in an Optical Signal-to-Noise Ratio (OSNR) penalty on the on-grid channel. For example, for 10 Gbps wavelengths, the resulting OSNR penalty is over 6 decibels (dB).

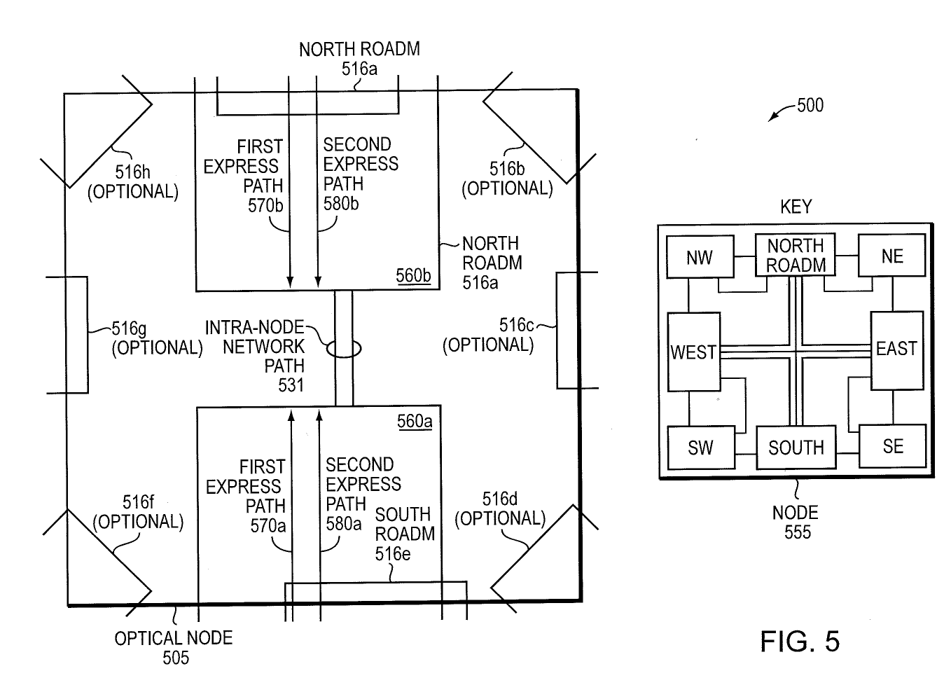

Example embodiments of the present invention described herein provide for placement of any number, relative to the capability or available space of a node, of 100 GHz ROADMs and 50 GHz ROADMs in the same network element, such as a network node defined, for example, as an 8-degree node (detailed below in reference to FIG. 5). Such example embodiments allow for the combination of 100 GHz ROADMs and 50 GHz ROADMs in one node. Such example embodiments can allow for 50 GHz off-grid channels to propagate between all 50 GHz ROADMs within the node, as well as allow for 100 GHz on-grid channels to propagate between all 100 GHz ROADMs within the node. Furthermore, example embodiments of the present invention allow for 100 GHz on-grid channels to propagate between each 50 GHz ROADM and each 100 GHz ROADM within the node.

It should be understood that 50 GHz spacing and 100 GHz spacing are merely examples of wavelength spacing in optical networks; embodiments of the invention can also be applied to other optical channel spacing or future legacy spacing in optical networks. For example, alternative example embodiments of the present invention can be used for technologies using different wavelength patterns, for example, 25 GHz spacing (e.g., ultra dense WDM). Further alternative embodiments of the present invention can be implemented in new amplification options that can enable the extension of usable wavelengths as are currently known or hereinafter developed and discovered relating to the capacity and channels used in optical networks.

As used herein, and unless otherwise denoted, the term “hybrid ROADM” refers to a ROADM capable of handling both on-grid and off-grid wavelengths (e.g., channels 1-88), and capable of being selectably configured (or programmed) to send a subset of channels to a 100 GHz non-hybrid ROADM. The phrase “non-hybrid ROADM” refers to legacy ROADMs, those which already exist, such as 50 GHz and 100 GHz ROADMs, but not selectably (or configurably) one or the other, where either term as used herein can mean manually or automatically arrangeable to enable the hybrid ROADM to communicate operatively with legacy and non-legacy ROADMs in efficient manners. For example, a ROADM capable of handling on-grid wavelengths only (i.e., channels 1-44) is a legacy ROADM, herein referred to as a 100 GHz non-hybrid ROADM or a 100 GHz ROADM. A second such legacy ROADM is a ROADM capable of also handling off-grid wavelengths (i.e., channels 45-88), but cannot be selectably configured (or programmed) to send a subset of channels to a 100 GHz non-hybrid ROADM. This second legacy ROADM is herein referred to as a 50 GHz non-hybrid ROADM or a 50 GHz ROADM.

For illustrative purposes, example embodiments presented herein are described in reference to 100 GHz spaced and 50 GHz spaced wavelengths. However, it should be understood that the example embodiments are applicable to other spacings of wavelengths, such as 50 and 25 GHz spacings, non-multiple spacings, etc. More generally, the example embodiments apply to wavelengths and a subset of the wavelengths, where, for example, the term “wavelength” can mean wavelengths corresponding to channels 1-88, which includes 50 GHz spaced channels (i.e., all channels) and the term “subset of the wavelengths” can mean wavelengths corresponding to channels 1-44, which includes 100 GHz spaced channels. The term “subset” can alternatively refer to other channels, consecutive or non-consecutive, among the “wavelengths.” It should be understood that channels 1-88 and 1-44 are used here as a convenient example; other channels at different corresponding wavelength spacings are also possible.

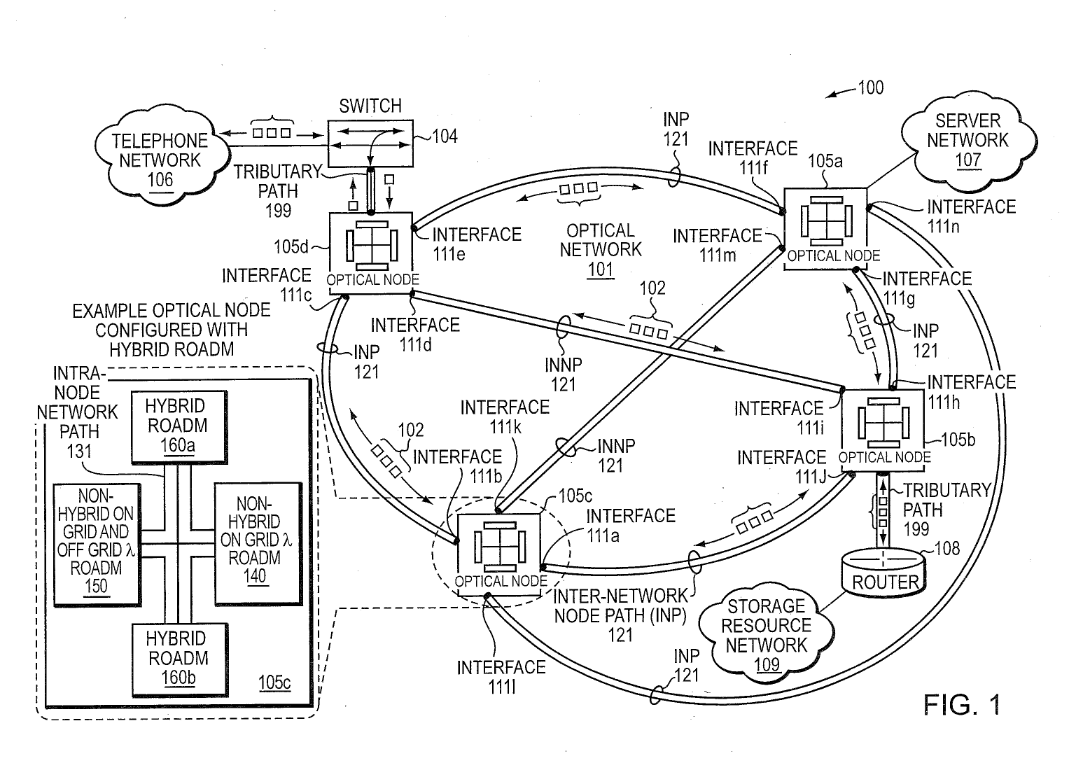

FIG. 1 is a network diagram of an example embodiment of the invention that illustrates an optical network 100. The optical network 100 can be any optical network or combination of optical networks, such as a Synchronous Optical Network (SONET) or mesh optical network and can include a plurality of network elements, such as optical nodes 105a-d. The optical network 100 can be logically or physically interconnected via tributary paths 199 with additional network components, such as an optical switch 104 or a router 108, or other network elements providing access to outside networks. Such outside networks can include, for example, a telephone network 106, a server network 107, a storage resources network 109, or other networks, network elements, or optical network components currently known in the art or hereafter developed. In alternative example embodiments of the network 100, the network devices, such as the nodes 105a-d can connect directly to outside networks, or elements thereof.

In the example embodiment of the optical network 100, the optical nodes 105a-d are interconnected via at least one inter-network node path (INNP) 121, which can be any suitable optical connection, such as a fiber optic cable, and include multiple optical network components. The example optical nodes 105a-d can include optical interfaces 111a-n, which can interface with the INNP 121 at specified positions, such as the available ports (not shown) to which to attach a fiber optic cable. In alternative example embodiments of the present invention, each node 105a-d may have different numbers of optical interfaces 111a-n available to be interfaced with the optical connection. Additionally, optical connections may be changed, updated, or modified to different capacity fibers as may be deemed necessary or beneficial. Each node 105a-d can be operably interconnected and maintain at least one reconfigurable optical add/drop multiplexer (ROADM), which can be configured to transmit and receive optical wavelengths, such as wavelength division multiplexed (WDM) signals. An example embodiment of the present invention illustrates optical node 105c configured with four interconnected ROADMs, where two of the ROADMs are hybrid-ROADMs 160a-b and two of the ROADMs are non-hybrid ROADMS. Specifically, in the case of a network with 100 GHz ROADMs and 50 GHz ROADMs, one of the non-hybrid ROADMs is a non-hybrid 50 GHz ROADM 150 and the other is a non-hybrid 100 GHz ROADM 140. Each of the ROADMs 160a-b, 150, and 140 are interconnected via an intra-node network path 131.

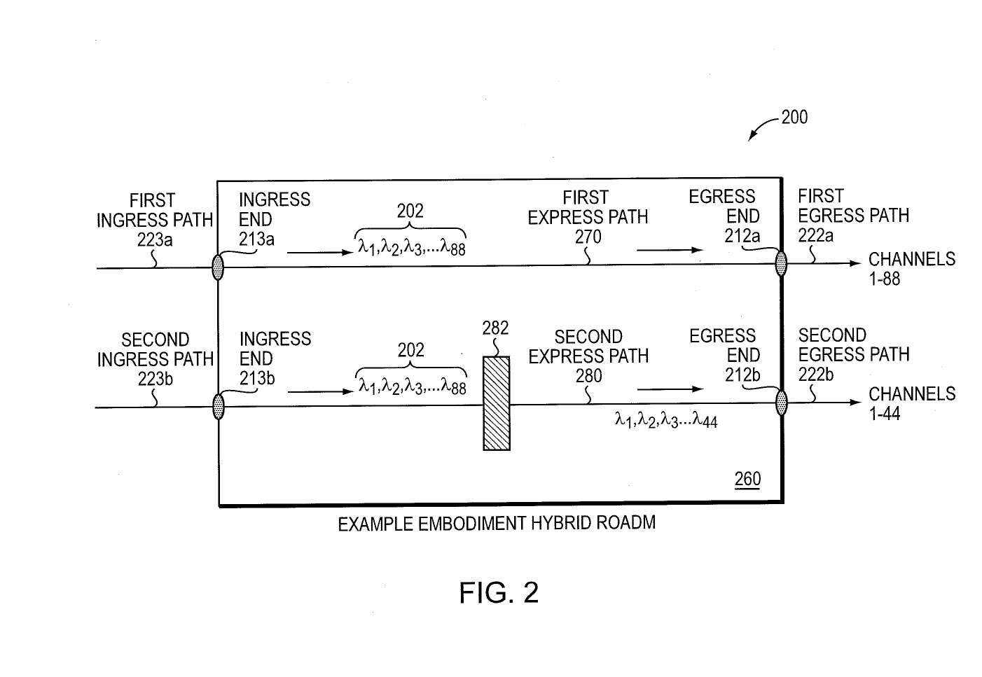

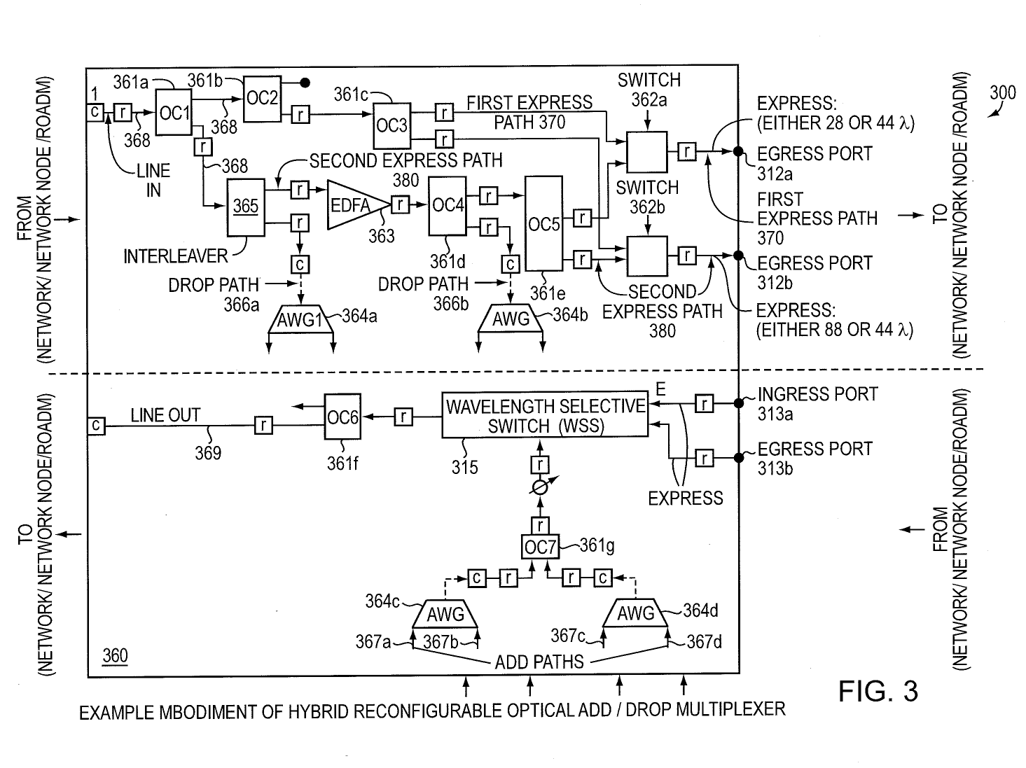

FIG. 2 is a block diagram 200 of an embodiment of the present invention that illustrates a hybrid reconfigurable optical add/drop multiplexer (hybrid ROADM) 260. The example embodiment 200 illustrates the hybrid ROADM 260 including a first express path 270 configured to pass wavelengths 202, such as wavelengths corresponding to channels 1-88, from an ingress end 213a of the hybrid ROADM to an egress end 212a of the hybrid ROADM 260. The example embodiment of the hybrid ROADM 260 further includes a second express path 280 that can be configured to receive wavelengths 202 corresponding to channels 1-88 but to restrict off-grid wavelengths (e.g., 100 GHz spaced wavelengths offset by 50 GHz from the on-grid wavelengths) and only pass the remaining wavelengths, the on-grid wavelengths 292 (e.g., legacy 100 GHz spaced wavelengths corresponding to channels 1-44), from the ingress end 213b of the second express path 280 to the egress end 212b of the second express path 280. To pass a subset of the wavelengths, the second express path 280 employs a selector (or restrictor) 282, depending on one's point of view.

In an example embodiment, the wavelengths 202 can include both on-grid and off-grid wavelengths (not shown), where the on-grid wavelengths are wavelengths that are spaced apart by 100 GHz and the off-grid wavelengths are wavelengths that are spaced apart by 100 GHz and offset from the on-grid wavelengths by 50 GHz. On-grid wavelengths are those wavelengths that are on the 100 GHz ITU grid, while off-grid wavelengths are those wavelengths that are not on the 100 GHz ITU grid, but instead offset from that grid by 50 GHz. In further example embodiments of the present invention, a first subset of wavelengths can include off-grid wavelengths but no on-grid wavelengths, and a second subset of the wavelengths, such as the wavelengths 292, can include on-grid wavelengths but no off-grid wavelengths. In example embodiments of the present invention, the ROADM 260 can be optically interconnected with at least a first egress path 222a and a second egress path 222b, where the first and second egress paths are different paths. Further example embodiments of the hybrid ROADM 260 can further be configured to receive optical signals via ingress paths, such as a first ingress path 223a of the first express path 270 and a second ingress path 223b of the second express path 280.

Alternative example embodiments of the present invention can include the egress side of the ROADM having the first and second egress paths coupled to a common egress port via a switch (not shown), or other such component. In further alternative example embodiments of the present invention, the first and second ingress paths 223a-b can be coupled to a common ingress port via a beam splitter or switch, or other optical component, or may be split or otherwise separated prior to entering the hybrid ROADM.

FIG. 3 is a block diagram 300 of an embodiment of the present invention that illustrates a hybrid reconfigurable optical add/drop multiplexer (hybrid ROADM) 360. An example embodiment of the present invention can further include the hybrid ROADM 360 being operably connected with a drop path or multiple drop paths, such as drop paths 366a-b, coupled to the second express path 380, and the second express path 380 is optionally configured or operable to be configured to pass all wavelengths to the first drop path 366a or a subset of the wavelengths, such as the off-grid wavelengths, to the first drop path 366a. Additionally, the second express path 380 is optionally configured or operable to be configured to pass a subset of wavelengths, such as the on-grid wavelengths to the second drop path 366b. Embodiments of the second express path 380 can include additional optical components, such as an optical filter or an interleaver 365. In the case of an interleaver 365 (or filter), the interleaver 365 may be configured or operable to be configured to restrict the off-grid wavelengths. The optical interleaver 365 can further be configured, for example, to separate the off-grid wavelengths from the on-grid wavelengths for purposes of passing just the on-grid wavelengths on the second express path 380. The interleaver 365 can further, or optionally, be configured to transmit or direct the on-grid wavelengths to the egress side of the ROADM.

Alternative example embodiments of the present invention can include the interleaver 365 configured or operable to be configured to direct the off-grid wavelengths to a first drop path of the ROADM and direct the on-grid wavelengths to a second drop path of the ROADM. The ROADM can further include any number of drop paths as may be required. The drop paths, which can be coupled to an ingress path or line-in 368 of the ROADM, can be configured to carry the wavelengths to at least one drop port coupled to the ROADM.

The array of two-to-one optical switches 362a-b, allow each express port 312a-b to be selectively configured to pass either all 88 wavelengths (i.e., both the on-grid and off-grid wavelengths) or 44 wavelengths (i.e., just the on-grid wavelengths). This can be accomplished by selectively configuring (or programming) each two-to-one optical switch 362a-b to select either the first express pass or the second express path. In alternative example embodiments, the optical switches can be removed, and the two sets of express paths can both be connected to output ports on the ROADM 360.

The optional optical amplifier 363, which may be implemented using an Erbium Doped Fiber Amplifier (EDFA) is used to boost the amplitude of the on-grid wavelengths exiting the express ports 312a-b from the second express path 380, in order to compensate for the insertion losses of the second express path 3. Alternatively, the optional optical amplifier 363 can be placed prior to the interleaver 365, such that both the on-grid and off-grid wavelengths traversing the second express path are amplified.

Key to the architecture of the ROADM 360 is the fact that wavelengths passing through the first express path do not traverse through the interleaver, and therefore do not suffer any filter narrowing effects associated with traversing through the interleaver filter. Therefore, wavelengths will only experience filter narrowing effects when traversing from an 88-channel portion of a given network to a 44 channel portion of the given network. Due to typical network topologies, the number of times a given wavelength traverses from an 88-channel portion of a given network to a 44 channel portion of the given network will be quite limited.

Whenever a wavelength passes through an optical amplifier (such as an EDFA), amplified spontaneous emission (ASE) noise is added to the wavelength. Since the optical amplifier 363 is placed only in the second express path, when a wavelength passes from the Line In port 368 to the express port 312a-b on the ROADM, the wavelength will only have ASE noise added to it when traversing from an 88-channel portion of a given network to a 44 channel portion of the given network.

Further example embodiments of the present invention can include the ROADM's multiple optical devices, such as amplifiers, optical couplers 361a-g, optical switches 362a-b, at least one wavelength selective switch (WSS) 315, array wavelength gratings (AWGs) 364a-d, add paths 367a-d, or other such optical devices currently used or hereinafter developed for use associated with reconfigurable add/drop multiplexing in optical networks.

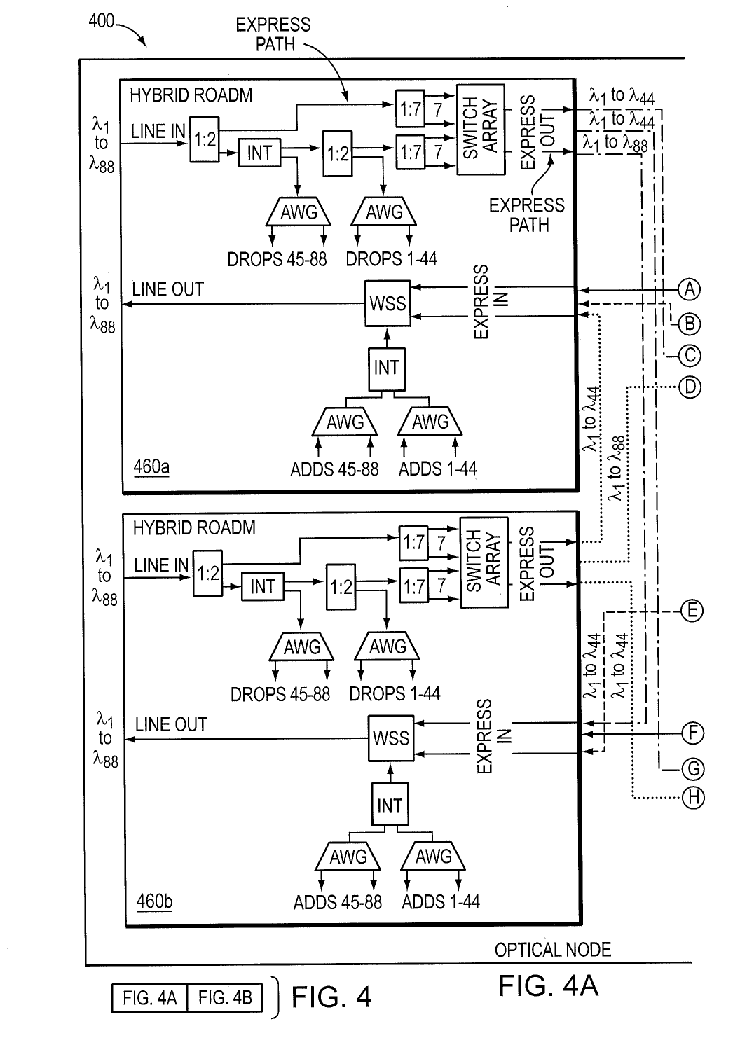

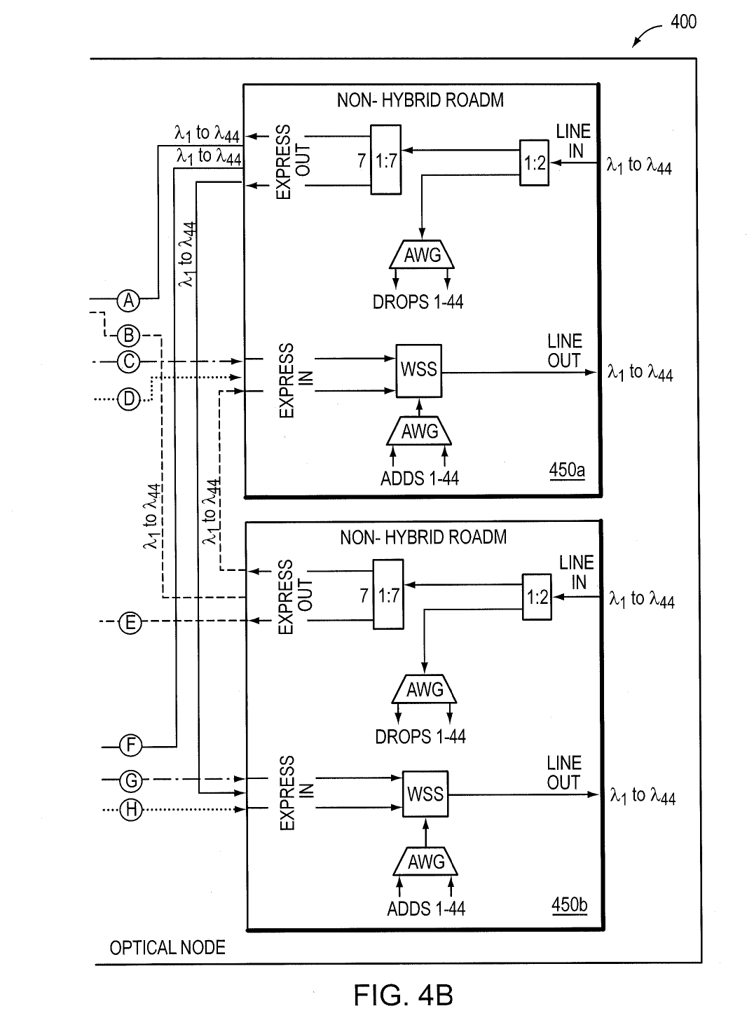

FIG. 4 is a block diagram 400 of an embodiment of the present invention that illustrates interconnected hybrid reconfigurable optical add/drop multiplexers (hybrid ROADMS) and non-hybrid ROADMS. In the block diagram 400, two of the ROADMs are hybrid ROADMs 460a-b and two of the ROADMs are 100 GHz non-hybrid ROADMs 450a-b. The two non-hybrid ROADMs 450a-b can exchange (e.g., transmit and receive) forty-four wavelengths (e.g., on-grid wavelengths, channels 1-44) with each other, and the two hybrid ROADMs 460a-b can be configured to exchange (e.g., transmit and receive) eighty-eight wavelengths with each other (e.g., both on-grid and off-grid wavelengths, channels 1-88). In addition, example embodiments of the present invention enable the two hybrid ROADMs 460a-b to be configured to exchange forty-four wavelengths (e.g., on-grid wavelengths, channels 1-44) with the two non-hybrid ROADMs 450a-b.

Alternative example embodiments of the hybrid ROADM allow for an 88-channel ROADM that can contain configurable wavelength band-blocking capabilities on its express output ports. Alternative example embodiments of the hybrid ROADM can allow for software programs to allow all eighty-eight channels (on-grid and off-grid channels) or only the first forty-four channels (on-grid channels) to be passed to each express output port. Such example embodiments allow for individual express output ports on the hybrid ROADM to be independently programmed to allow the combination of 88-channel and 44-channel ROADMs to work together within a given optical node.

Further still, the example hybrid ROADM can employ an interleaver (“INT” in FIG. 4) found in existing 88-channel ROADMs, albeit used in a different configuration and for a different purpose, and includes an array of seven optical switches (e.g., 2×1 optical switches). In an example embodiment of the present invention, a hybrid ROADM can maintain at least two express paths (see FIGS. 2 and 3 and corresponding descriptions) from the ingress side of the hybrid ROADM to the egress side of the hybrid ROADM, where a first express path is capable of trafficking all of the wavelengths (e.g., an 88-wavelength path) and a second express path can traffic a subset of the wavelengths (e.g., a 44-wavelength path). In an example embodiment of the present invention, an interleaver, such as a drop interleaver, can be employed to filter the forty-four on-grid wavelengths from the off-grid wavelengths. Furthermore, example embodiments can include each express out port and can be independently programmed via its corresponding optical switch (e.g., 2×1 optical switch) or other mechanism known in the art or hereinafter developed.

FIG. 5 illustrates a block diagram 500 of an example embodiment of an optical node 505 according to example embodiments of the present invention. The example embodiment of the optical node 505, such as the optical node 105d in FIG. 1, can be a multi-degree optical node, where the optical node can include or be operably interconnected to at least two ROADMs 560a-b. The first ROADM 560a can be selectably configured or is operable to be configured to traffic wavelengths via a first express path 570a or the first ROADM 560a can be selectably configured or is operable to be configured to traffic only a subset of the wavelengths, e.g., the on-grid wavelengths, via a second express path 580a. The first ROADM 560a being configured to be optically coupled to a second ROADM 560b via an intra-node network path 531. The second ROADM can be selectably configured or is operable to be configured to receive the wavelengths or the subset of the wavelengths and to traffic wavelengths received via an express path.

Additional example embodiments of the block diagram 500 can include a multi-degree optical node 505, where the first ROADM 560a can be selectably or fixedly configured to traffic the wavelengths or the subset of the wavelengths as a function of wavelength capacity of the second ROADM 560b. Further, the multi-degree optical node 505 can include additional ROADMs, such additional ROADMs being operably interconnected at open slots 516a-h, where each “slot” is considered a “degree.” In other words, in the example optical node 505, the node can be an eight-degree (8D) node, where the “degrees” represent connection points in different actual (i.e., or physical) directions located on the optical node 505. For example, the node key 555 illustrates the cardinal points and ordinal points as would be the directions of the 8D node slots. Alternative example embodiments can include a third ROADM that can be operatively interconnected to an empty slot 516g, which would correspond to the cardinal point “West.” As many intra-node network paths 531 as needed to interconnect the ROADMs may be employed within the optical node 505.

In such embodiments, the first ROADM, for example, can further be configured or is operable to be configured to traffic the wavelengths or subset of the wavelengths to the second and third ROADMs as a function of their respective wavelength capacities. In other example embodiments of the present invention, additional ROADMs (hybrid or non-hybrid) may be operatively interconnected as needed, limited only as a function of available space on the node. Further still, example embodiments of the present invention can include a multi-degree optical node, where the second ROADM can include a Wavelength Selective Switch (WSS) configured to receive the wavelengths or the subset of the wavelengths, and further be configured to provide wavelengths received or a further subset of the wavelengths received to an express path of the second ROADM.

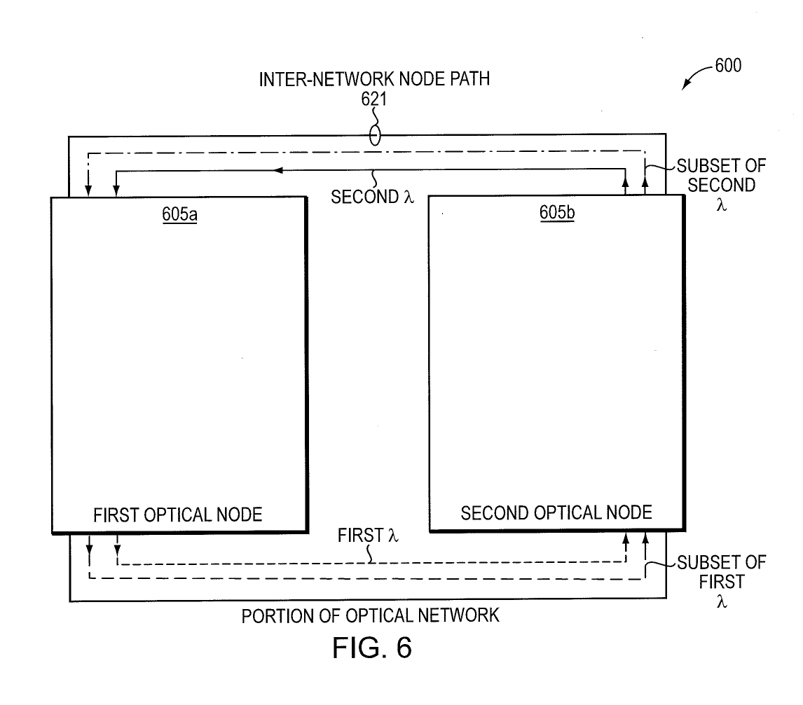

FIG. 6 is an optical network diagram 600 of an embodiment of the present invention that illustrates at least two optical nodes, such as nodes 105c and 105d in FIG. 1. The example embodiment illustrates the first optical node 605a being operably interconnected to the second optical node 605b via at least one inter-network node path (INNP) 621, such as the INNP 121 of FIG. 1. The first optical node 605a can be selectably configured to traffic first wavelengths consisting of, for example, either on-grid and off-grid wavelengths or a subset of the first wavelengths consisting of, for example, only on-grid wavelengths, and the second optical node 605b can be similarly or differently configured (as to the first optical node) to traffic second wavelengths. In such an example embodiment, the first optical node 605a can be configured or is operable to be configured to traffic the first wavelengths to the second optical node 605b if the first wavelengths correspond to the second wavelengths. The first optical node can further be configured to traffic the subset of the wavelengths if the subset of the wavelengths corresponds to the second wavelengths.

In alternative example embodiments of the optical network 600, the first optical node 605a can be further configured to serve as a gateway node, which can operably interconnect an on-grid and off-grid portion of the network (not shown) and/or an on-grid-only portion of the network (not shown). Such an example optical network can be, for example, an interconnected dense wavelength division multiplexing optical network.

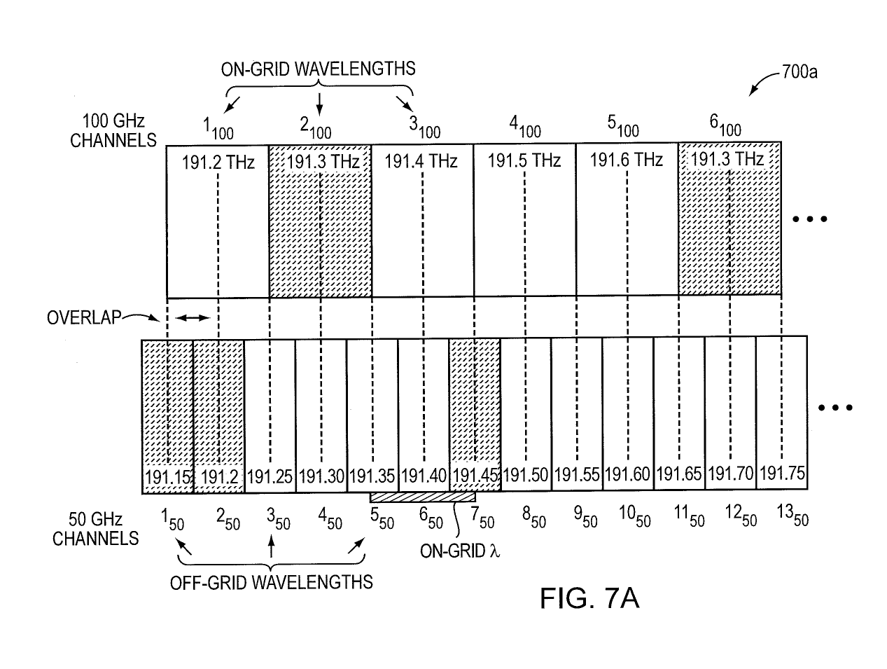

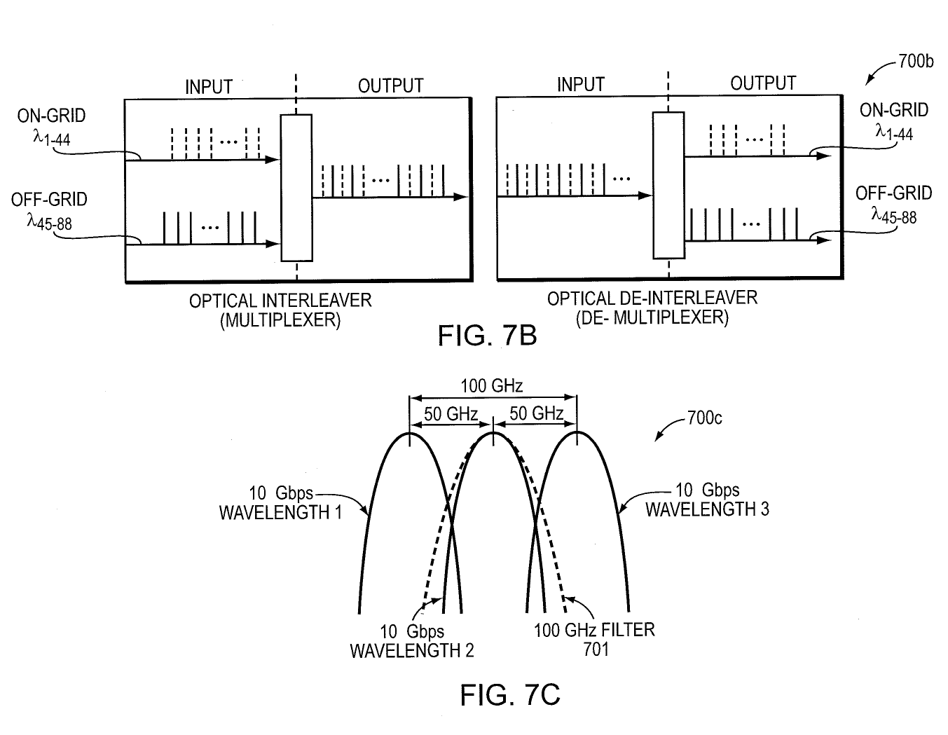

FIG. 7A is a diagram 700a of an example embodiment of the present invention that illustrates the possible interference or overlap problems associated with 100 GHz channels and 50 GHz channels, which can be made to function without interference using example embodiments of the present invention. In one such example, 10 Gbps signals originating on 100 GHz ROADMs require one 50 GHz ROADM channel, whereas some 40 Gbps signal types originating on 100 GHz ROADMs may require three 50 GHz ROADM channels (e.g., slots) to avoid performance penalties due to cross-talk (e.g., a signal transmitted on one channel creates an unwanted or other effect on another channel).

In alternative example embodiments of the block diagram 700a, a core 88-channel network may be combined with a 44-channel network on the peripheral. Furthermore, example embodiments of the diagram 700a illustrate that only channels 1-44 (i.e., on-grid wavelengths in this network illustration) may be used between 100 GHz nodes and that channels 1-88 (i.e., on-grid and off-grid wavelengths in this network illustration) may be used between 50 GHz interconnected nodes. In an example embodiment, 100 GHz spaced wavelengths transmitted or received via 50 GHz nodes may, to some extent, follow optical rules of the 50 GHz system.

FIG. 7B is a block diagram 700b that illustrates an optical interleaver and de-interleaver of an example embodiment of the present invention. Such example embodiments of the present invention can employ an interleaver to multiplex and de-multiplex optical wavelengths in an optical network, a network element, or a ROADM.

Alternative example embodiments of the present invention can include a single component type that can be utilized as both an interleaver, to interleave two streams, and a de-interleaver, to de-interleave two streams.

FIG. 7C is a spectral diagram 700c that illustrates the possible interference or cross-talk problems associated with using 100 GHz filter to filter out the center wavelength of three consecutive 10 Gbps wavelengths that are spaced apart by 50 GHz. Specifically, such the example embodiment of diagram 700c illustrates the spectrums of three consecutive 10 Gbps wavelengths spaced apart by 50 GHz. The 100 GHz filter 701 is represented by the dashed line in FIG. 7C. As is illustrated in the figure, in addition to the entire spectrum of wavelength 2, portions of wavelengths 1 and 3 are also contained within the 100 GHz filter, resulting in noise penalties to the desired filtered wavelength 2. This diagram thus illustrates the problems associated with sending 50 GHz spaced signals to 100 GHz spaced ROADMs.

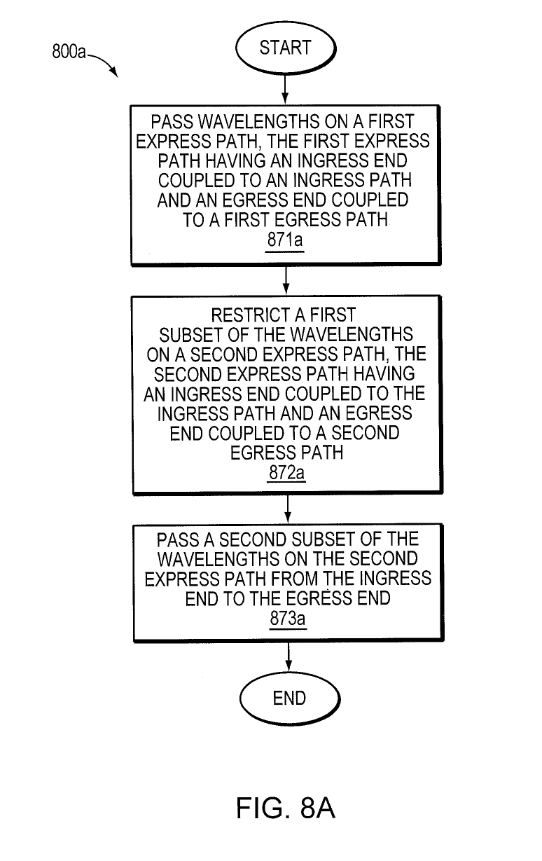

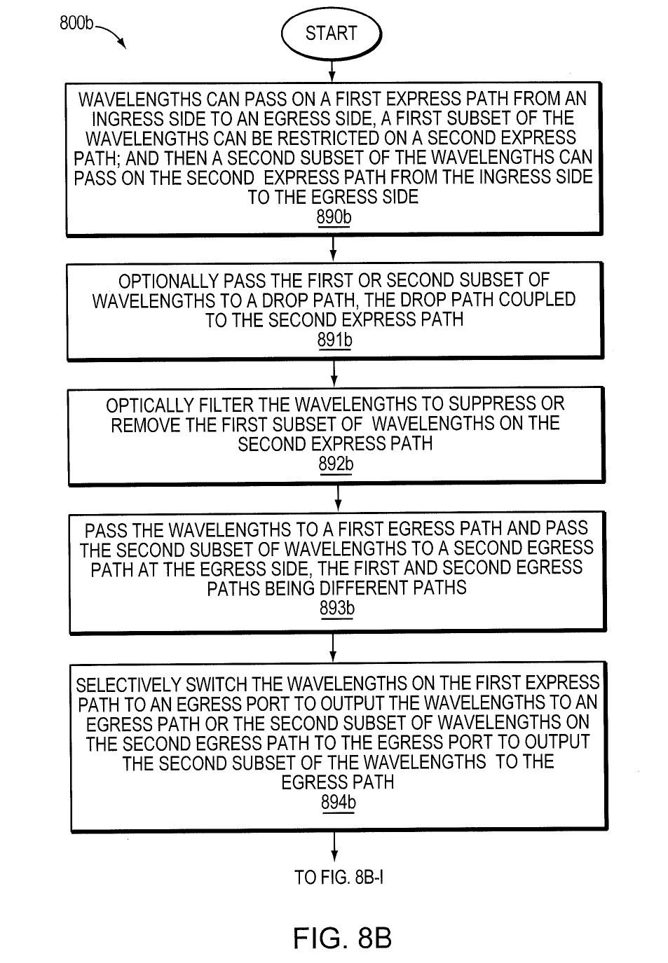

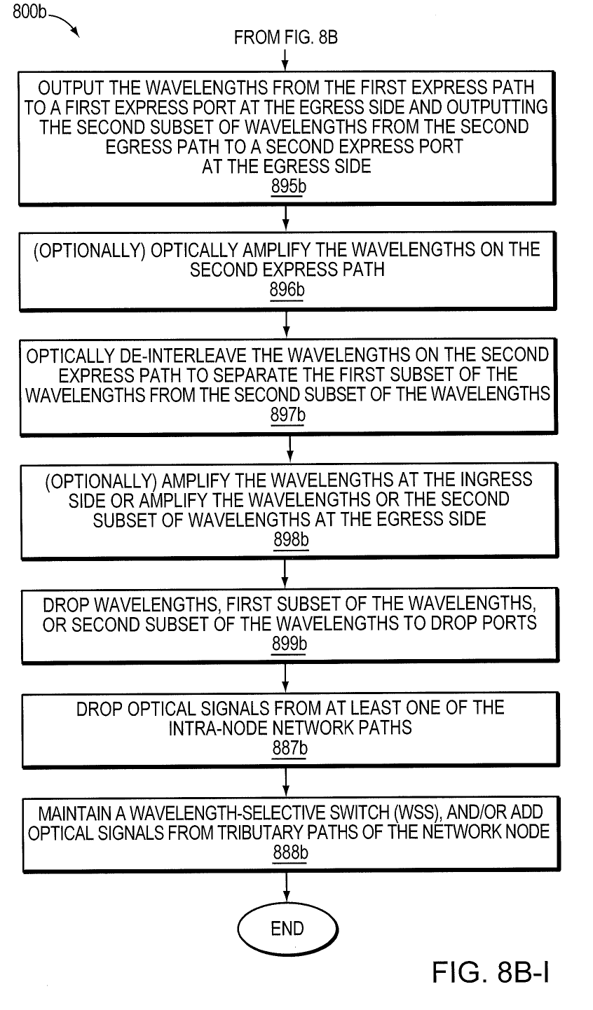

FIG. 8A is a flow diagram 800a of an embodiment of the present invention that illustrates a method of trafficking optical signals. Example embodiments can be performed in a network device, such as the hybrid ROADM 360 in FIG. 3. After beginning, the flow diagram 800a passes wavelengths on a first express path, the first express path having an ingress end coupled to an ingress path and an egress end coupled to a first egress path (871a). The flow diagram 800a restricts a first subset of the wavelengths on a second express path, the second express path having an ingress end coupled to the ingress path and an egress end coupled to a second egress path (872a). The method further passes a second subset of the wavelengths on the second express path from the ingress end to the egress end (873a).

FIG. 8B is a flow chart 800b of an embodiment of the present invention that illustrates a method of trafficking optical signals. Example embodiments can be performed in a network device, such as the hybrid ROADM 360 in FIG. 3. In an example embodiment of the procedure of FIG. 8B, wavelengths can pass on a first express path from an ingress side to an egress side, a first subset of the wavelengths can be restricted on a second express path; and then a second subset of the wavelengths can pass on the second express path from the ingress side to the egress side (890b). In an example embodiment, the wavelengths can include both on-grid and off-grid wavelengths, where the on-grid wavelengths are wavelengths that are spaced apart by 100 gigahertz (GHz) and the off-grid wavelengths are wavelengths that are spaced apart by 100 GHz and further offset from the on-grid wavelengths by 50 GHz. The procedure of FIG. 8B can optionally pass the first or second subset of wavelengths to a drop path, the drop path being coupled to the second express path (891b). The procedure can optically filter the wavelengths to suppress or remove the first subset of wavelengths on the second express path (892b), and, further, can pass the wavelengths to a first egress path and pass the second subset of wavelengths to a second egress path at the egress side, the first and second egress paths being different paths (893b).

Alternative example embodiments of the procedure of FIG. 8B can selectively switch the wavelengths on the first express path to an egress port to output the wavelengths to an egress path or the second subset of wavelengths on the second egress path to the egress port to output the second subset of the wavelengths to the egress path (894b). Further, the wavelengths can be outputted from the first express path to a first express port at the egress side, and the second subset of wavelengths can be outputted from the second egress path to a second express port at the egress side (895b). Further alternative example embodiments of the procedure of FIG. 8B include being enabled to optically amplify the wavelengths on the second express path (896b), optically de-interleave the wavelengths on the second express path to separate the first subset of the wavelengths from the second subset of the wavelengths (897b), and/or amplify the wavelengths at the ingress side or amplify the wavelengths or the second subset of wavelengths at the egress side (898b). Additional embodiments of the procedure can drop all of the wavelengths, first subset of the wavelengths, or second subset of the wavelengths to drop ports (899b), drop optical signals from at least one of the intra-node network paths (887b), maintain a wavelength-selective switch (WSS), and/or add optical signals from tributary paths of the network node (888b).

Further alternative example embodiments of the procedure of FIG. 8B can include adding additional channels to the optical network and upgrading a non-hybrid ROADM capable of handling only the subset of the wavelengths with a replacement ROADM. Example embodiments of such a replacement ROADM can be a hybrid ROADM or non-hybrid ROADM capable of handling all of the wavelengths, thereby allowing the wavelengths to pass through the given ROADM toward the replacement ROADM.

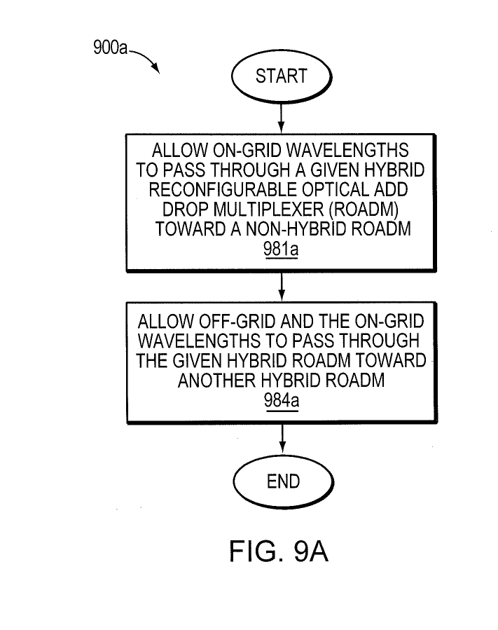

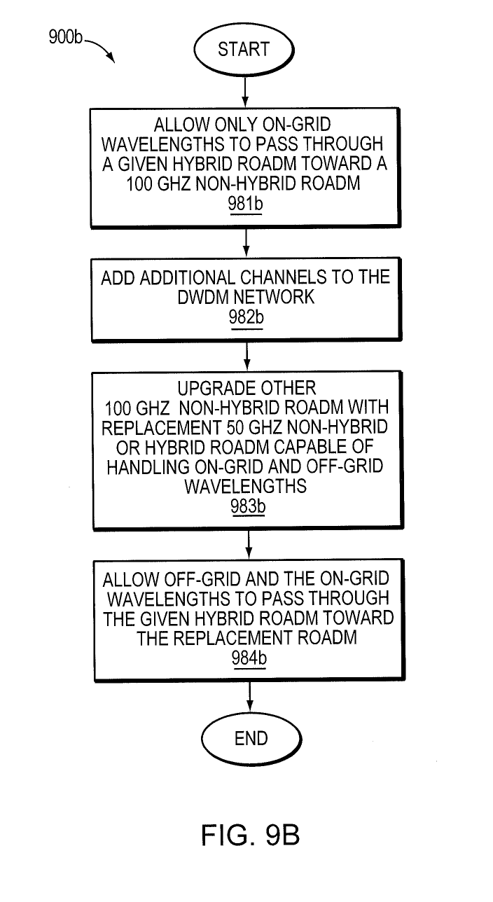

FIG. 9A is a flow diagram 900a of an embodiment of the present invention that illustrates a method of trafficking an optical signal. After beginning, the flow diagram 900a allows only on-grid wavelengths to pass through a given hybrid Reconfigurable Optical Add Drop Multiplexer (ROADM) toward a 100 GHz non-hybrid ROADM (981a). The example method of flow diagram 900a further allows off-grid and the on-grid wavelengths to pass through the given hybrid ROADM toward another hybrid ROADM (984a) or a 50 GHz non-hybrid ROADM.

FIG. 9B is a flow chart 900b of an embodiment of the present invention that illustrates a method of trafficking an optical signal. After beginning, the flow chart 900b allows only on-grid wavelengths to pass through a given hybrid ROADM toward a 100 GHz non-hybrid ROADM (981b). The example embodiment can further allow for the addition of additional channels (by, for example, a method of multiplexing or de-multiplexing wavelengths) to the DWDM network (982b). The flow chart 900b can further upgrade other 100 GHz non-hybrid ROADMs with replacement 50 GHz non-hybrid or hybrid ROADMs capable of handling on-grid and off-grid wavelengths (983b), and allow off-grid and the on-grid wavelengths to pass through the given hybrid ROADM toward the replacement ROADMs (984b).

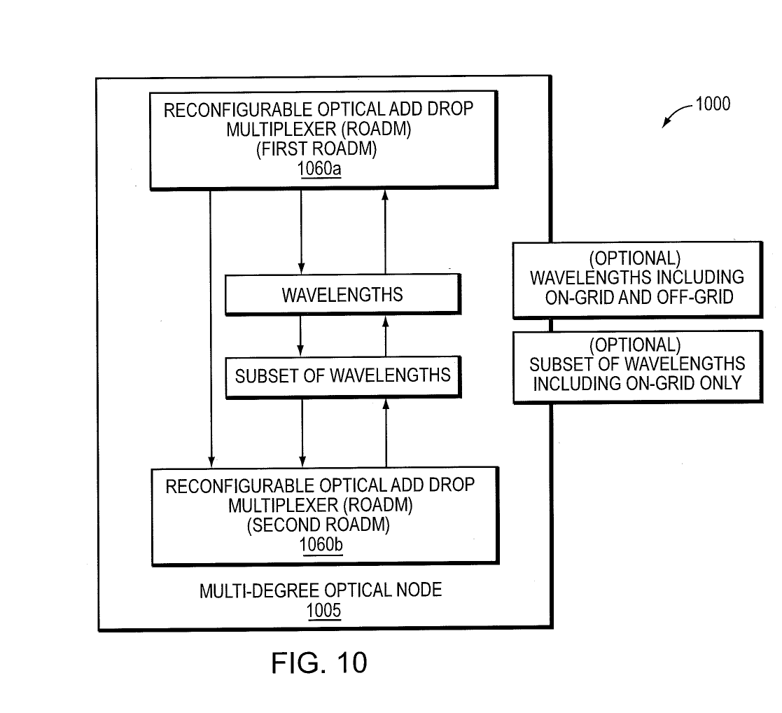

FIG. 10 is a block diagram 1000 of a network apparatus 1005, such as the optical node 105c in FIG. 1, according to an example embodiment of the present invention. Components of the optical node 1005 can include a first reconfigurable optical add drop multiplexer (ROADM) 1060a and a second ROADM 1060b, which can be operably interconnected in a manner as set forth above, for example, as set forth in FIG. 1 and FIG. 5 and their respective descriptions. According to the example embodiment, the first ROADM 1060a can traffic (e.g., transmit, receive, exchange, etc.) wavelengths or subsets of wavelengths to the second ROADM 1060b.

In alternative example embodiments of the block diagram 1000, the second ROADM 1060b can traffic wavelengths or subsets of wavelengths to the first ROADM 1060a. In further example embodiments of the present invention, both the first and second ROADMs may exchange collateral information, as may be common in the art; additionally, the ROADMs can be individually programmed to perform or send and receive information as per coded instructions. In alternative example embodiments of the present invention, the network apparatus 1005 of block diagram 1000 can be a multi-degree optical node, such as the optical node 505 in FIG. 5.

Alternative example embodiments of the present invention allow for an optical network based on a 44-channel network to be upgraded to an 88-channel network by upgrading at least one ROADM at a time. In one such alternative example, only the on-grid wavelengths, channels 1-44, can be used while the entire network, portion of the network, or a network element is being upgraded. Further, the original 44-channel network may be designed or implemented using optical rules associated with an 88-channel optical network. In further alternative example embodiments of the present invention, a network operating with channels 1-88, which mixes 50 GHz ROADMs and 100 GHz ROADMs in the same network element, such as a network node, may cause failure. Network nodes containing only 100 GHz ROADMs can be interconnected to nodes containing 50 GHz ROADMs, but the 50 GHz ROADMs will transmit channels 1-44 to the 100 GHz ROADMs. In such alternative example embodiments, a network having both 50 GHz nodes (i.e., nodes comprised of 50 GHz ROADMs) interconnected to 100 GHz nodes (i.e., nodes comprised of 100 GHz ROADMs), channels 45-88 may be first be assigned to the connections between the 50 GHz nodes, which allows for a maximum number of wavelengths for transmission between 100 GHz nodes across a 50 GHz core network.

In alternative example embodiments of the present invention, a hybrid ROADM can fully interoperate with existing 100 GHz spaced ROADMs while also providing 50 GHz spaced ROADM capability. Such an embodiment can allow 100 GHz spaced wavelengths to pass (e.g., transmitted and received) between the hybrid ROADM and an existing 100 GHz spaced ROADM. In addition, such an example embodiment can allow 50 GHz spaced wavelengths to pass between the hybrid ROADM and other hybrid ROADMs, and other 50 GHz spaced ROADMs. In further alternative example embodiments of the present invention, a hybrid ROADM can provide two wavelength paths in at least one direction, where the first path is configured or is operable to be configured to carry 50 GHz spaced wavelengths and the second path is configured or is operable to be configured to carry only 100 GHz spaced wavelengths. In such an example embodiment of a hybrid ROADM with 50 GHz spaced wavelengths being transmitted or received on a path, the 50 GHz spaced wavelength path does not pass through any optical filters prior to being emitted on an interconnected express output port; as such, the 50 GHz spaced wavelengths do not suffer effects of filter narrowing. Such example embodiments of express output ports can be configured to be independently programmable to transmit or pass 50 GHz spaced wavelengths or only 100 GHz spaced wavelengths.

In further alternative example embodiments, an optical interleaver can be employed to separate the on-grid wavelengths from the off-grid wavelengths. Such an example interleaver can be used to separate (i.e., de-interleave) the on-grid and off-grid wavelengths for both on- and off-grid drop ports and express ports. Further example embodiments may maintain an optical interleaver attached directly to a ROADM, or operatively interconnected thereto, but such interleaver can be programmed or reprogrammed not to separate the on- and off-grid wavelengths that can be dropped via the drop ports.

Further example embodiments of the present invention allow a ROADM with at least two express paths to receive all wavelengths (e.g., channels 1-88) via a line-in interface and can simultaneously drop the received wavelengths via at least one drop port to be sent to all express output ports. In further example embodiments, only the on-grid wavelengths on the 100 GHz express output path and the on-grid wavelengths being dropped via the at least one drop port may be amplified. Alternatively, the on-grid wavelengths on the 100 GHz express output path and both the on-grid and off-grid wavelengths being dropped via at least one drop path are amplified. Further still, the on-grid wavelengths, off-grid wavelengths, or both may be dropped via a single array wavelength grating (AWG) or via multiple AWGs.

An alternative example embodiment of the present invention can include a hybrid ROADM that allows for any mixture of 44-channel and 88-channel ROADMs within the same system, while providing a complete interconnection between all ROADMs in the system. In one such example embodiment, in regard to the add and drop ports, array wavelength gratings (AWGs) with 100 GHz spacing and 50 GHz shape (i.e., bandwidth) can be used. For an example embodiment employing AWGs for use with add and drop ports, the interleavers used in alternative example embodiments of the present invention for the adding and dropping of optical signals, wavelengths, or subsets thereof, can be replaced with a simple optical coupler (e.g., a 1:2 optical coupler). In an example embodiment, one set of AWGs can be offset in frequency by 50 GHz, such that the AWGs can filter the off-grid wavelengths. In further alternative example embodiments, in regard to add and drop ports, 88-channel AWGs with 50 GHz spacing and 50 GHz shape (i.e., bandwidth) can be employed. In one such example embodiment, no interleavers or couplers are necessary for the adding and dropping of optical signals, wavelengths, or subsets thereof.

Further alternative example embodiments of the present invention can include a method and apparatus for adding additional wavelengths to an optical node, where such a process can include replacing at least one 100 GHz ROADM with at least one hybrid ROADM. Such an example embodiment or alternative example embodiments, as detailed herein, may include a method and apparatus for adding wavelengths in a dense wavelength division multiplexed (DWDM) network.

It is further contemplated that alternative example embodiments of the present invention may include multiple express paths, such as three or more express paths, optically interconnected to a hybrid ROADM as the future need for additional transport differently-spaced wavelengths may require. For example, one embodiment of a hybrid ROADM may include a 25 GHz spacing express path, a 50 GHz spacing express path, and a 100 GHz spacing express path, where the 50 and 100 GHz spacing express paths may employ interleavers or other optical elements as described herein to effectuate separation of the 50 GHz and 100 GHz spaced wavelength subsets from the full set of wavelengths (i.e., the 25, 50 and 100 GHz spaced wavelengths). Furthermore, a three-to-one switch (or two two-to-one switches configured so as to enable a three-to-one switching function) may be utilized to switch one of three types of express paths (i.e., 25 GHz, 50 GHz, and 100 GHz) to a common express port.

Further example embodiments may include mixtures of hybrid and non-hybrid ROADMs in network nodes greater than eight degrees.

Further example embodiments of the present invention may be configured using a computer program product; for example, controls may be programmed in software for implementing example embodiments of the present invention. Further example embodiments of the present invention may include a non-transitory computer readable medium containing instruction that may be executed by a processor, and, when executed, cause the processor to traffic wavelengths of different spacings within an optical node or optical network. It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read only memory (CD-ROM), and so forth. In operation, a general purpose or application specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the invention.

While this invention has been particularly shown and described with references to example embodiments thereof, it will be understood by those skilled in the art that various changes in form and details may be made therein without departing from the scope of the invention encompassed by the appended claims.

What is claimed is:

1. A Reconfigurable Optical Add Drop Multiplexer (ROADM), comprising:
a first express path configured or operable to be configured to pass wavelengths received from an ingress side toward an egress side; and
a second express path configured or operable to be configured to restrict a first subset of the wavelengths and to pass a second subset of the wavelengths from the ingress side toward the egress side.

2. The ROADM of claim 1 wherein the wavelengths include on-grid and off-grid wavelengths, the first subset of the wavelengths includes off-grid wavelengths and no on-grid wavelengths, and the second subset of the wavelengths includes on-grid wavelengths and no off-grid wavelengths.

3. The ROADM of claim 2 wherein the on-grid wavelengths are wavelengths spaced apart by 100 gigahertz (GHz) and off-grid wavelengths are wavelengths spaced apart by 100 GHz and offset from the on-grid wavelengths by 50 GHz.

4. The ROADM of claim 1 wherein the ROADM further comprises a drop path coupled to the second express path, and wherein the second express path is optionally configured or operable to be configured to pass the first or second subset of wavelengths to the drop path.

5. The ROADM of claim 1 wherein the second express path includes an optical filter configured or operable to be configured to restrict the first subset of the wavelengths.

6. The ROADM of claim 1 wherein the egress side includes first and second egress paths, which are different paths.

7. The ROADM of claim 1 wherein the egress side includes first and second egress paths coupled to a common egress port via a switch.

8. The ROADM of claim 1 wherein the egress side includes first and second egress paths coupled to a respective express egress ports.

9. The ROADM of claim 1 wherein the second express path includes an optical amplifier.

10. The ROADM of claim 1 wherein the second express path includes an optical interleaver configured or operable to be configured to separate the first subset of the wavelengths from the second subset of the wavelengths, the optical interleaver being further configured or operable to be configured to direct the second subset of the wavelengths to the egress side.

11. The ROADM of claim 10 wherein the second subset of the wavelengths are on-grid wavelengths.

12. The ROADM of claim 10 wherein the optical interleaver is further configured or operable to be configured to direct the first subset of the wavelengths to a first drop path.

13. The ROADM of claim 10 wherein the optical interleaver is further configured or operable to be configured to direct the second subset of the wavelengths to a second drop path.

14. The ROADM of claim 1 further comprising a drop path coupled to an ingress path, the drop path configured or operable to be configured to carry the wavelengths to drop ports.

15. The ROADM of claim 1 wherein the ROADM is one of multiple ROADMs within a network node, and wherein:
the first and second express paths are a portion of corresponding intra-node network paths between at least two ROADMs within the network node, the ROADM further comprising:
at least one drop path configured or operable to be configured to drop optical signals from at least one of the intra-node network paths; and wherein the ROADM still further comprises:
a wavelength-selective switch (WSS), the WSS optically interconnected to a third intra-node network path from among the multiple ROADMs; and
at least one add path configured or operable to be configured to add optical signals from tributary paths.

16. A method for trafficking an optical signal in a Reconfigurable Optical Add Drop Multiplexer (ROADM), the method comprising:
passing wavelengths on a first express path from an ingress side to an egress side;
restricting a first subset of the wavelengths on a second express path; and
passing a second subset of the wavelengths on the second express path from the ingress side to the egress side.

17. The method of claim 16 wherein the wavelengths include on-grid and off-grid wavelengths, the first subset of the wavelengths includes off-grid wavelengths and no on-grid wavelengths, and the second subset of the wavelengths includes on-grid wavelengths and no off-grid wavelengths.

18. The method of claim 17 wherein the on-grid wavelengths are wavelengths spaced apart by 100 gigahertz (GHz) and off-grid wavelengths are wavelengths spaced apart by 100 GHz and offset from the on-grid wavelengths by 50 GHz.

19. The method of claim 16 further comprising optionally passing the first or second subset of wavelengths to a drop path, the drop path coupled to the second express path.

20. The method of claim 16 wherein restricting the first subset of the wavelengths includes optically filtering the wavelengths to suppress or remove the first subset of wavelengths on the second express path.

21. The method of claim 16 wherein passing the wavelengths and the second subset of the wavelengths includes passing the wavelengths to a first egress path and passing the second subset of wavelengths to a second egress path at the egress side, the first and second egress paths being different paths.

22. The method of claim 16 further comprising selectively switching the wavelengths on the first express path to an egress port to output the wavelengths to an egress path or the second subset of wavelengths on the second egress path to the egress port to output the second subset of the wavelengths to the egress path.

23. The method of claim 16 further comprising outputting the wavelengths from the first express path to a first express port at the egress side and outputting the second subset of wavelengths from the second egress path to a second express port at the egress side.

24. The method of claim 16 further comprising optically amplifying the wavelengths on the second express path.

25. The method of claim 16 further comprising optically de-interleaving the wavelengths on the second express path to separate the first subset of the wavelengths from the second subset of the wavelengths.

26. The method of claim 16 further comprising amplifying the wavelengths at the ingress side or amplifying the wavelengths or the second subset of wavelengths at the egress side.

27. The method of claim 16 further comprising dropping the wavelengths, first subset of the wavelengths, or second subset of the wavelengths to drop ports.

28. The method of claim 16 wherein the ROADM is one of multiple ROADMs within a network node, and wherein:
the first and second express paths are a portion of corresponding intra-node network paths between at least two ROADMs within the network node, the method further comprising:
dropping optical signals from at least one of the intra-node network paths; and wherein the method still further comprising:
maintaining a wavelength-selective switch (WSS), the WSS optically interconnected to a third intra-node network path from among the multiple ROADMs; and
adding optical signals from tributary paths of the network node.

29. A multi-degree optical node, comprising:
a first Reconfigurable Optical Add Drop Multiplexer (ROADM) selectably configured or operable to be configured to traffic wavelengths via a first express path or a subset of the wavelengths via a second path; and
a second ROADM optically coupled to the first ROADM and configured or operable to be configured to receive the wavelengths or the subset of the wavelengths and to traffic wavelengths received via an express path.

30. The multi-degree optical node of claim 29 wherein the wavelengths include on-grid and off-grid wavelengths and the subset of the wavelengths includes only on-grid wavelengths.

31. The multi-degree optical node of claim 30 wherein the on-grid wavelengths are wavelengths spaced apart by 100 gigahertz (GHz) and off-grid wavelengths are wavelengths spaced apart by 100 GHz and offset from the on-grid wavelengths by 50 GHz.

32. The multi-degree optical node of claim 30 wherein the first ROADM is selectably or fixedly configured to traffic the wavelengths or the subset of the wavelengths as a function of wavelength capacity of the second ROADM.

33. The multi-degree optical node of claim 30 further comprising a third ROADM, the first ROADM configured to traffic the wavelengths or subset of the wavelengths to the second and third ROADMs as a function of their respective wavelength capacities.

34. The multi-degree optical node of claim 29 wherein the first ROADM comprises a switch selectably configurable to direct the wavelengths or subset of the wavelengths to traverse the first and second express paths to the second ROADM.

35. The multi-degree optical node of claim 29 wherein the second ROADM includes a Wavelength Selective Switch (WSS) configured or operable to be configured to receive the wavelengths or the subset of the wavelengths and provide wavelengths received or a further subset of the wavelengths received to an express path of the second ROADM.

36. An optical network, the network comprising:
a first optical node selectably configured to traffic first wavelengths or a subset of the first wavelengths; and
a second optical node configured to traffic second wavelengths, the first optical node and second optical node being operably interconnected via at least one inter-network node path, the first optical node configured to traffic the first wavelengths to the second optical node if the first wavelengths correspond to the second wavelengths and configured to traffic the subset of the first wavelengths if the subset of the wavelengths corresponds to the second wavelengths.

37. The optical network of claim 36 wherein the first wavelengths include on-grid and off-grid wavelengths and the subset of the first wavelengths includes on-grid wavelengths and no off-grid wavelengths.

38. The optical network of claim 37 wherein the on-grid wavelengths are wavelengths spaced apart by 100 gigahertz (GHz) and off-grid wavelengths are wavelengths spaced apart by 100 GHz and offset from the on-grid wavelengths by 50 GHz.

39. The optical network of claim 36 wherein the first optical node is further configured to serve as a gateway node to operably interconnect an on-grid and off-grid portion of the network and an on-grid only portion of the network.

40. The optical network of claim 36 wherein the network is an interconnected dense wavelength division multiplexing optical network.

41. A method for trafficking an optical signal in an optical network, the method comprising:
allowing a subset of wavelengths to pass through a given hybrid Reconfigurable Optical Add Drop Multiplexer (ROADM) toward a non-hybrid ROADM capable of handling only the subset of the wavelengths; and
allowing off-grid and the on-grid wavelengths to pass through the given hybrid ROADM toward another hybrid ROADM or a non-hybrid ROADM capable of handling all of the wavelengths.

42. The method of claim 41 further comprising:
adding additional channels to the optical network;
upgrading a non-hybrid ROADM capable of handling only the subset of the wavelengths with a replacement ROADM, the replacement ROADM being a hybrid ROADM or non-hybrid ROADM capable of handling all of the wavelengths; and
allowing the wavelengths to pass through the given ROADM toward the replacement ROADM.

43. The method of claim 41 wherein the wavelengths include on-grid and off-grid wavelengths and the subset of the wavelengths include on-grid wavelengths and no off-grid wavelengths.
